(19) United States
(12) Patent Application Publication
(10) Pub. No.: US 2006/0215244 A1
(43) Pub. Date: Sep. 28, 2006

(54) Vehicle display system

(76) Inventors: Jacob Yosha, Shoham (IL); Bezalei Levi, Nes Iona (IL); Tsadock Dabby-Dvir, Kiryat Savionim (IL); Igor Friedland, Shoham (IL)

Correspondence Address: LATHROP & GAGE LC, 2345 GRAND AVENUE, SUITE 2800, KANSAS CITY, MO, 64108, US

(21) Appl. No.: 11/443,720

(22) Filed: May 31, 2006

Related U.S. Application Data
(63) Continuation of application No. PCT/IL04/01094, filed on Nov. 30, 2004.

(30) Foreign Application Priority Data
Dec. 2, 2003 (IL) 159159
Nov. 24, 2004 (IL) 1655376

(51) Int. Cl. G02B 5/32

(52) U.S. Cl. 359/15

(57) ABSTRACT

System for displaying an incident image for an operator of a vehicle, the system including an optical assembly receiving the incident image from an image source, and a planar optical module optically coupled with the optical assembly, the optical assembly producing a collimated light beam according to the incident image, the planar optical module being located in a line of sight of the operator, the planar optical module displaying a set of output decoupled images, each of the output decoupled images being similar to the incident image, and each of the output decoupled images having a focal point substantially located at an infinite distance from the operator.

### RELATED APPLICATIONS

This application is a continuation of PCT/IL2004/001094, filed Nov. 30, 2004, which claimed priority to Israeli patent application serial numbers IL 159159, filed Dec. 2, 2003 and IL 165376, filed Nov. 24, 2004; each of these applications is incorporated herein by reference.

### FIELD OF THE INVENTION

The disclosed technique relates to display systems in general, and to methods and systems for displaying images in a vehicle, in particular.

### BACKGROUND OF THE INVENTION

The driver of a ground vehicle uses the information displayed on the instrument panel, such as speed, fuel supply, engine revolutions per minute (RPM), and route finder, to drive the vehicle and navigate toward a desired location. The pilot of an aircraft depends on the data displayed on the instrument panel even more than the driver of the vehicle, in order to fly and navigate the aircraft, and particularly in order to take part in a midair combat, or to fire at a target on the ground. The gages on the instrument panel are generally referred to as head down display (HDD).

The outside scene (e.g., pedestrians, nearby vehicles, closely flying aircraft, landing approach lights, targets seen on the ground from the aircraft) are located far away from either the driver or the pilot (i.e., from the point of view of the driver or the pilot, the focal point of the outside scene is located at infinity). However, the focal point of the HDD, are only a few tens of centimeters away from the driver or the pilot. Therefore, the driver or the pilot has to change his eye focus when switching his view from the HDD, to the scene outside of the vehicle or the aircraft, and refocus when switching back to the HDD.

It is a well known fact that this refocusing task causes great eye fatigue, and furthermore reduces the driving efficiency or the flying efficiency of the driver or the pilot, thereby causing road accidents in case of a vehicle, or causing disorientation in case of the pilot of a plane. Systems and methods for reducing the visual stress on the driver or the pilot, are known in the art.

For example, head up displays (HUD), display the temporally relevant information in front of the windshield or the canopy (i.e., the usual point of the driver or the pilot), and thus free the driver or the pilot to look down to the HDD to find the relevant information. A system is known in the art (U.S. Pat. No. 6,392,812 B1, as briefly described herein below), for displaying information for the pilot in front of the canopy (i.e., a HUD), at infinity. However, this system requires bulky optics, which significantly taxes the aircraft design in terms of space, weight, and cost. Furthermore, this same optics holds back the possibility of incorporating this infinity-displaying feature with an HDD.

On the other hand, vibrations due to the aircraft engine usually reach the HDD in the cockpit, thereby blurring the view of the HDD and making it difficult for the pilot to use the information displayed on the HDD. The driver of a ground vehicle is confronted with the same problem, while driving on a rough terrain. Therefore, there is a need to provide a system which enables the driver or the pilot to use the information on the HUD or the HDD, efficiently, despite the vibrations.

U.S. Pat. No. 6,392,812 B1 issued to Howard and entitled “Head Up Displays”, is directed to a head up display system for displaying an image to the pilot of an aircraft, at infinity. The HUD includes an image generator, a housing, a holographic combiner, an optical sub-system, an object surface and an exit pupil. The optical sub-system includes a relay lens arrangement, a prism and a mirror. The holographic combiner includes a holographic reflection lens coating at an interface between two glass material elements. The prism includes a first reflective surface and a second reflective surface. The first reflective surface includes a first portion and a second portion. The second reflective surface includes a first portion and a second portion.

The housing is located below a canopy of the aircraft. The image generator, the optical sub-system, the object surface and the exit pupil are located inside the housing. The holographic combiner is located between the canopy and the eyes of the pilot. The relay lens arrangement is located between the image generator and the prism. The object surface is located between the image generator and the relay lens arrangement. The exit pupil is located between the relay lens arrangement and the prism. The prism is located between the holographic combiner and the mirror.

The first reflective surface is located between the prism and the mirror. The second reflective surface is located between the prism and the holographic combiner, such that the first reflective surface is located below the second reflective surface. The first portion of the first reflective surface is arranged to totally internally reflect an image produced by the image generator, within the prism, while the second portion of the first reflective surface is arranged to allow the image to pass there through. The first portion of the second reflective surface is arranged to totally internally reflect an image produced by the image generator, within the prism, while the second portion of the second reflective surface is arranged to allow the image to pass there through.

The image generator generates an image at the object surface and the relay lens arrangement receives the image, collimates the image and conveys the image to the exit pupil. The image follows an optical path way from the object surface to the holographic combiner. The first reflective surface and the second reflective surface are coplanar, and define a narrowing taper in the direction of propagation of the image along the optical path way. A mirror surface of the mirror is coplanar with the first reflective surface and the second reflective surface.

The image is totally internally reflected from the first portion of the first reflective surface toward the first portion of the second reflective surface, where it is totally internally reflected through the second portion of the first reflective surface, which is arranged to allow the image to pass there through. The image is then reflected by a mirror surface of the mirror, back through the second portion to the first reflective surface, and through the second portion of the second reflective surface, which is arranged to allow the image to pass there through. The image leaves the prism through the exit pupil and falls on the interface of the holographic combiner, which is arranged to overlay the image on a scene viewed by the eyes of the pilot. In this manner, the pilot observes the image at infinity, overlaid on the scene through the holographic combiner.

PCT Publication WO 99/52002, entitled “Holographic Optical Devices”, is directed to a holographic display device. The device includes a first HOE, a second HOE and a third HOE located on a substrate. A light source illuminates the first HOE. The first HOE collimates the incident light from the light source, and diffracts the light into the substrate. The substrate traps the diffracted light therein, so that the light propagates through the substrate by total internal reflection along a first axis toward the second HOE.

The second HOE has the same lateral dimension as the first HOE along a second axis normal to the first axis. The lateral dimension of the second HOE along the first axis is substantially larger than the lateral dimension of the first HOE. The diffraction efficiency of the second HOE increases gradually along the first axis.

The second HOE diffracts the light into the substrate. The substrate traps the light therein, so that the light propagates through the substrate by total internal reflection, toward the third HOE along the second axis. The third HOE has the same lateral dimension as the second HOE along the first axis. The third HOE has the same lateral dimensions along the first and the second axes. The diffraction efficiency of the third HOE increases gradually along the second axis. The sum of the grating functions of the first, second and third axes, is zero.

PCT Publication No. WO 01/95027 A2 entitled “Substrate-Guided Optical Beam Expander”, is directed to a method for coupling light from a collimated display and trapping it inside a substrate by total internal reflection. The substrate includes a reflecting surface at one side, and a parallel array of reflecting surfaces on the other side thereof. The collimated display is located behind the substrate, at the same side of a viewer.

The reflecting surface reflects the incident light from the collimated display, such that the light is trapped inside the substrate by total internal reflection. After a few reflections inside the substrate, the trapped waves reach the parallel array of partially reflecting surfaces, and the parallel array of partially reflecting surfaces couple the light out of the substrate into the eye of the viewer. Each reflector of the parallel array of partially reflecting surfaces, couples part of the trapped waves out of the substrate, and transmits the rest to a subsequent reflector. Incident light can be coupled into the substrate by folding prism, fiber optic bundle, and diffraction grating.

U.S. Pat. No. 6,639,569 B2 issued to Kearns et al., and entitled “Integrated Heads-Up Display and Cluster Projection Panel Assembly for Motor Vehicles”, is directed to an assembly which conveys information onto the windshield of a motor vehicle and onto the instrument panel of the motor vehicle. The assembly includes a housing for housing an integrated HUD and cluster projection panel. The integrated HUD and cluster projection panel includes a HUD unit, a cluster projection panel unit and a display unit. The HUD unit includes a first angle to area converter, a first plurality of light emitting diodes (LEDs), a fold mirror and a first projection optic. The cluster projection panel unit includes a second plurality of LEDs, and a second projection optic.

The first projection optic includes plastics for magnifying and projecting light beams. The second projection optic includes plastics for magnifying and projecting light beams. The display unit includes an array of pixels which are selectively controlled to transmit and reflect light by sequencing on and off.

The display unit is located between the first plurality of a LEDs and the second plurality of LEDs on one side, and the fold mirror and the second projection optic on the other. The first projection optic is located below the windshield. The second projection optic is located behind a cluster projection screen of the motor vehicle.

The first angle to area converter includes a first large end a first small end. The second angle to area converter includes a second large end and a second small end. The first plurality of LEDs load the first angle to area converter with light, at the first large end thereof. The first angle to area converter outputs a first high flux light beam at a larger angle from the first small end. The second plurality of LEDs load the second angle to area converter with light, at the second large end thereof. The second angle to area converter outputs a second high flux light beam at a larger angle from the second small end. The pixels of the display unit selectively transmit and reflect light from the first high flux light beam and from the second high flux light beam, to form a first image light beam and a second image light beam, respectively. The first image light beam and the second image light beam are typically different images, having shapes.

A first pixel array portion of the display unit transmits the first image light beam toward the fold mirror. The fold mirror reflects the first image light beam toward the first projection optic. The first projection optic magnifies and projects the reflected first image light beam on the windshield. A second pixel array portion of the display unit transmits the second image light beam toward the second projection optic. The second projection optic magnifies and projects the second image light beam onto the cluster projection screen.

### SUMMARY OF THE INVENTION

It is an object of the disclosed technique to provide a novel system for displaying an incident image for an operator of a vehicle, which overcomes the disadvantages of the prior art.

In accordance with the disclosed technique, there is thus provided a system for displaying an incident image for an operator of a vehicle. The system includes an optical assembly receiving the incident image from an image source, and a planar optical module optically coupled with the optical assembly. The optical assembly produces a collimated light beam according to the incident image.

The planar optical module is located in a line of sight of the operator. The planar optical module displays a set of output decoupled images, each of the output decoupled images being similar to the incident image, and each of the output decoupled images having a focal point substantially located at an infinite distance from the operator.

### BRIEF DESCRIPTION OF THE DRAWINGS

The disclosed technique will be understood and appreciated more fully from the following detailed description taken in conjunction with the drawings in which:

FIG. 1 is a schematic illustration of a system for displaying a plurality of virtual images respective of an incident image, having a focal point substantially located at infinity, against a scene image of an object substantially located at infinity, constructed and operative in accordance with an embodiment of the disclosed technique;

FIG. 2 is a schematic illustration of a system for displaying a plurality of virtual images respective of an incident image, having a focal point substantially located at infinity, constructed and operative in accordance with another embodiment of the disclosed technique;

FIG. 3 is a schematic illustration of a system for displaying two sets of virtual images respective of two incident images, having focal points substantially located at infinity, constructed and operative in accordance with a further embodiment of the disclosed technique;

FIG. 4 is a schematic illustration of a planar optical module similar to the planar optical module of the system of FIG. 1, and the planar optical module of the system of FIG. 2, constructed and operative in accordance with another embodiment of the disclosed technique;

FIG. 5 is a schematic illustration of a system for displaying a plurality of virtual images respective of an incident image having a focal point substantially located at infinity, against a scene image of an object substantially located at infinity, constructed and operative in accordance with a further embodiment of the disclosed technique; and

FIG. 6 is a schematic illustration of a controller of the system of FIG. 5.

### DETAILED DESCRIPTION OF THE INVENTION

The disclosed technique overcomes the disadvantages of the prior art by providing a planar optical device which transforms and displays a plurality of virtual images whose focal points are substantially located at infinity and which are derived from a substantially small image source. The planar optical device can be located in the line of sight of an observer looking toward a scene substantially located at infinity, in which case the observer observes one virtual image at a time, against a scene image of the scene, and wherein the device operates as a head up display (HUD). Alternatively, the planar optical device can be located on an instrument panel of a cockpit of an aircraft or the driver compartment of a vehicle, in which case the planar optical device operates as a head down display (HDD).

Each of the virtual images is similar to an incident image produced by the substantially small image source, and the observer can observe a virtual image of the same incident image, from different locations relative to the planar optical device. Thus, if the head of the observer is moving relative to the planar optical device due to vibrations in the navigation compartment, the observer can still obtain a substantially sharp and blur-free view of the incident image, despite the vibrations.

The term “vehicle” herein below, refers to ground vehicle (e.g., automobile, cargo vehicle, bus, bicycle, motorcycle, tank, rail vehicle, armored vehicle, snowmobile), aircraft (e.g., airplane, rotorcraft, amphibian), marine vehicle (e.g., cargo vessel, resort ship, aircraft carrier, battle ship, submarine, motor boat, sailing boat), spaceship, spacecraft, and the like. The term “navigation compartment” herein below, refers to a compartment in which a pilot, a driver, a sailor, an astronaut, and the like, is situated to operate the vehicle. Hence, navigation compartment can refer to a cockpit as well as a driving compartment. The term “operator” herein below, refers to a person who operates the vehicle, such as a pilot, a driver, a sailor, an astronaut, and the like.

The term “beam transforming element” (BTE) herein below, refers to an optical element which transforms an incident light beam. Such a BTE can be in form of a single prism, refraction light beam transformer, diffraction light beam transformer, and the like. A refraction light beam transformer can be in form of a prism, micro-prism array, Fresnel lens, gradient index (GRIN) lens, GRIN micro-lens array, and the like. A micro-prism array is an optical element which includes an array of small prisms on the surface thereof. Similarly, a GRIN micro-lens array is an optical element which includes an array of small areas having an index profile similar to a saw tooth, thereby acting similar to a micro-prism array. The periodicity of a diffraction BTE is usually greater than that of a refraction BTE.

A diffraction light beam transformer can be in form of a diffraction optical element, such as hologram, kinoform, and the like, surface relief grating, volume phase grating, and the like. A surface relief grating is much finer (having a grating spacing of the order of the incident wavelength, and having periodic forms such as a saw tooth, sinusoid or slanted sinusoid) than a Fresnel lens or a micro-prism (having spacings of the order of hundreds of micrometers). A volume phase grating is a BTE constructed of a plurality of optical layers, each having a selected index of refraction, which together provide a diffraction grating effect. Thus, the surface of volume phase grating is smooth.

The term “microgroove direction” herein below, refers to the longitudinal direction of the microgrooves of a BTE. The microgroove direction of a first BTE relative to the microgroove direction of an adjacent second BTE, dictates the amount of rotation of the optical axis from the first BTE to the second BTE. The frequency of grating of the BTE is herein below referred to as “spatial frequency”.

The term “planar light guide” herein below, refers to a transparent layer within which a plurality of BTEs are located. Alternatively, one or more BTEs are located on the surface of the planar light guide. The planar light guide can be made of plastic, glass, quartz crystal, and the like, for transmission of light in the visible range. The planar light guide can be made of infrared amorphous or crystalline materials such as, germanium, zinc-sulphide, silver-bromide, and the like, for transmission of light in the infrared range. The planar light guide can be made of a rigid material, as well as a flexible material.

The term “design eye point” (DEP) herein below, refers to the location of the eyes of the operator according to which the visually observable position and location of the instruments in the navigation compartment are determined. At the DEP, the operator can observe the ambient scene outside of the vehicle, and also one of the virtual images produced by the planar optical device. The term “instantaneous field of view” (INFOV) herein below, refers to the union of two solid angles subtended at each eye of the operator, by the planar optical device according to the disclosed technique, at the DEP. The term “eyebox” herein below, refers to a three-dimensional spatial volume within which the operator can move his head and his eyes about the DEP, and still observe the virtual images produced by the planar optical device according to the disclosed technique.

The term “total field of view” (TFOV) herein below, refers to the union of solid angles subtended at each eye, by the planar optical device according to the disclosed technique, from all locations within the eyebox. TFOV defines the maximum angular extent of the planar optical device which can be seen by each eye, taking into account the movement of the eyes and the head. TFOV is generally expressed as degrees vertical and degrees horizontal.

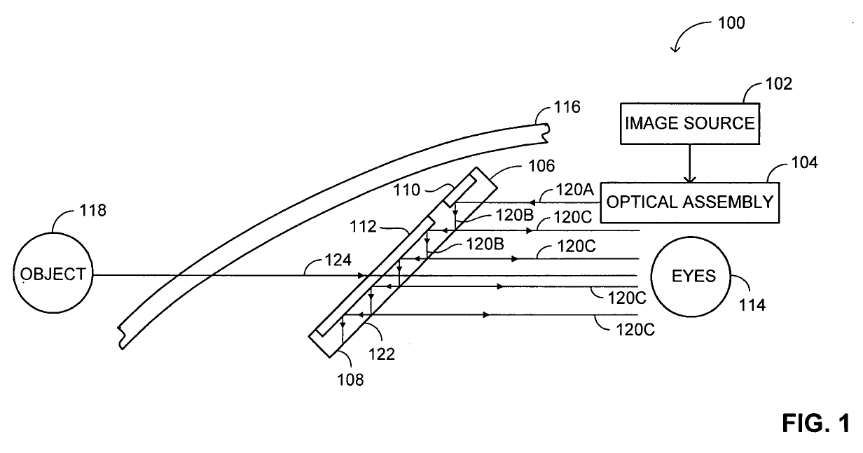

Reference is now made to FIG. 1, which is a schematic illustration of a system, generally referenced 100, for displaying a plurality of virtual images respective of an incident image having a focal point substantially located at infinity, against a scene image of an object substantially located at infinity, constructed and operative in accordance with an embodiment of the disclosed technique. System 100 includes an image source 102, an optical assembly 104 and a planar optical module 106. Planar optical module 106 includes a planar light guide 108, an input BTE 110 and an output BTE 112.

Image source 102 is a device which produces an incident image (not shown) to be seen by eyes 114 of an operator (not shown), operating a vehicle (not shown). Image source 102 can be a liquid crystal display (LCD), light emitting diode (LED), organic light emitting diode (OLED), cathode ray tube (CRT), liquid crystal on silicon (LCOS), stationary laser, scanned laser (i.e., an optical assembly which directs a laser beam to raster like scan a surface back and forth), scanned light emitting diode, hot cathode fluorescent lamp (HCFL), cold cathode fluorescent lamp (CCFL), incandescent light element, flat panel display, starlight scope, still image projector (slides, digital camera), and the like.

In case the image source is in form of a display, an image detector detects an image and provides the display a respective electronic signal. The image detector provides the display an electronic signal respective of the detected image, and the display provides the detected image to the optical assembly in optical form. The image detector can be a near infrared (NE) image intensifier tube (i.e., either a still image camera or a video camera), charge coupled device (CCD) camera, mid-to-far infrared image camera (i.e., thermal forward-looking infrared—thermal FLIR camera), computer, visible light video camera, and the like. The image source can produce the incident image either in gray scale (i.e., black and white or shades of gray against a white background), or in color scale.

Optical assembly 104 is a device which converts a spherical wave field (i.e., converging or diverging—uncollimated light beams), to a collimated field. Since the collimated light beams are mutually parallel, the operator perceives a focal point of an image (not shown) respective of these collimated light beams to be located substantially at infinity. For this purpose, optical assembly 104 can in form of a collimator.

Image source 102 is coupled with optical assembly 104. Planar optical module 106 is optically coupled with optical assembly 104.

Each of input BTE 110 and output BTE 112 is located on a surface of planar light guide 108. Alternatively, each of input BTE 110 and output BTE 112 is embedded within planar light guide 108. The arrangement of planar optical module 106 where one input BTE and one output BTE are incorporated therewith, is herein below referred to as “doublet”. The contour of each of input BTE 110 and output BTE 112 can be rectangular or square. The surface area of output BTE 112 is substantially greater than that of input BTE 110. Planar optical module 106 is located behind a windshield 116 of the vehicle, and in a line of sight of eyes 114 of the operator to an object (i.e., a scene) 118.

Optical assembly 104 receives a light beam (not shown) from image source 102, respective of the incident image, converts this light beam to a collimated light beam 120A, and directs collimated light beam 120A toward input BTE 110. The angle (not shown) between collimated light beam 120A and a surface 122 of planar light guide 108 is herein below referred to as “incidence angle”. In order to simplify the description, in the example set forth in FIG. 1, image source 102 and optical assembly 104 are located above the operator and in line with windshield 116. However, in practice, the image source and the optical assembly can be located below the windshield, wherein the optical assembly directs the collimated light beam toward the input BTE, from behind.

Input BTE 11O couples collimated light beam 120A, into planar light guide 108 as a set of coupled light beams 120B. Since the index of refraction of planar light guide 108 is greater than that of the surrounding medium (e.g., air), the set of coupled light beams 120B propagates within planar light guide 108 by total internal reflection (TIR) and repeatedly strikes output BTE 112. At each instance, output BTE 112 decouples a first portion (not shown) of coupled light beams 120B and transforms the first portion into decoupled light beams 120C, out of planar light guide 108 toward eyes 114, thereby forming an output decoupled image (not shown). A second portion (not shown) of coupled light beams 120B continues to propagate within planar light guide 108 by TIR, and again strikes output BTE 112.

Output BTE 112 transforms the remaining portion of coupled light beams 120B to decoupled light beams 120C. The above process continues and repeats several times, wherein remaining portions of coupled light beams 120B continue to strike output BTE 112 several times and additional decoupled light beams (not shown) are decoupled by output BTE 112. Thus, a plurality of output decoupled images are formed, wherein each output decoupled image is similar to the incident image produced by image source 102. In this manner, eyes 114 can observe a respective output decoupled image at each location of the eyes within the eyebox, and perceive each output decoupled image to originate substantially from a location at infinity. The angle (not shown) between decoupled light beams 120C and surface 122, is herein below referred to as “output angle”.

Object 118 is located substantially at a an infinite distance from the pilot. Windshield 116 and planar optical module 106 transmit a light beam 124 from object 118 toward eyes 114. In this manner, eyes 114 can observe an output decoupled image respective of the incident image, against a scene image (not shown) of object 118, and perceive the focal point of the output decoupled image to be located substantially at the same focal point as that of object 118 (i.e., at infinity). Thus, system 100 operates as a HUD.

It is an inherent property of planar optical module 106, that output BTE 112 decouples decoupled light beams 120C at an output angle (not shown), substantially equal to the incidence angle. Hence, optical assembly 104 directs collimated light beam 120A at an incidence angle substantially equal to an angle (not shown) between light beam 124 and surface 122. Moreover, since light beam 120A is collimated, decoupled light beams 120C are also collimated.

It is noted that since the focal points of the output decoupled image and object 118 are substantially the same, the operator does not have to focus eyes 114 back and forth between object 1 18 and the output decoupled image. Thus, system 100 relieves the operator from considerable eye stress which is inherent in conventional HUDs and HDDs. It is further noted that since planar optical module 106 forms a plurality of output decoupled images similar to the incident image produced by image source 102, the operator can observe substantially the same output decoupled image at different locations within the eyebox. This feature allows the operator more freedom of movement during navigation of the vehicle, and the designer of the navigation compartment more freedom in taking into account operators of different musculoskeletal properties. It is noted that since the surface area of input BTE 110 is substantially small, the physical dimensions of each of image source 102 and optical assembly 104 can be substantially small.

When a moving observer is viewing a conventional image located in a relatively short range, such as that of a printed page or a cathode ray tube display, during movements of the head she has to move her eyeballs according to the movements of the head, in order to keep viewing the conventional image. Hence, the eyes of the moving observer viewing a conventional image from short range, are readily fatigued. These head movements are present for example, when the moving observer is traveling in a vehicle on a rough road.

On the other hand, a moving observer who is viewing a relatively remote object, such as a house located far away, she does not have to move her eyeballs in order to keep viewing the remote object. This is due to the fact that the light beam reaching the moving observer from the remote object, are parallel (as if the remote object was located at infinity) and in form of plane waves. This type of viewing is the least stressing to the eyes, and it is herein below referred to as “biocular viewing”.

As the head (not shown) of the moving observer moves relative to planar optical module 106, eyes 114 detect the output decoupled image which is transformed by output BTE 112 at a region of output BTE 112, corresponding to the new location of the observer relative to planar optical module 106. Hence, during movements of the head, the eyeballs (not shown) of eyes 114 do not have to move in order to keep viewing the output decoupled image, and the eyeballs are minimally stressed. Thus, planar optical module 106 provides the moving observer, a biocular view of an image representing the incident image. The spatial frequency of input BTE 110 and output BTE 112 is such that the moving observer perceives a stationary and continuous view of the output decoupled image, with no jitters or gaps in between.

When a stationary observer views a conventional image from short range, the perceived image is somewhat distorted (i.e., aberrations are present). This is due to the fact that the light beams emerging from the conventional image, reach each of the two eyes in a different angle. Since the light beams reaching the two eyes are not parallel, a parallax error is present in the observed view.

On the other hand, the light beams emerging from a device similar to planar optical module 106 are in form of plane waves (i.e., parallel) and they reach the two eyes at the same angle. In this case, no parallax error is present and the observed view is biocular.

System 100 can further include a processor and a communication interface, wherein the processor is coupled with image source 102 and with the communication interface. In this case, image source 102 is in form of a display which produces an optical image according to an electronic signal received from the processor. The communication interface is coupled with a data source either via a conductive connection (e.g., electric conductor, optical fiber), or through the air interface (i.e., wireless).

The processor produces the electronic signal (e.g., video signal, still image signal) according to a signal received from the communication interface and provides the electronic signal to image source 102. Optical assembly 104 receives the optical image from image source 102 and optical assembly 104 directs collimated light beam toward input BTE 110, according to the optical image.

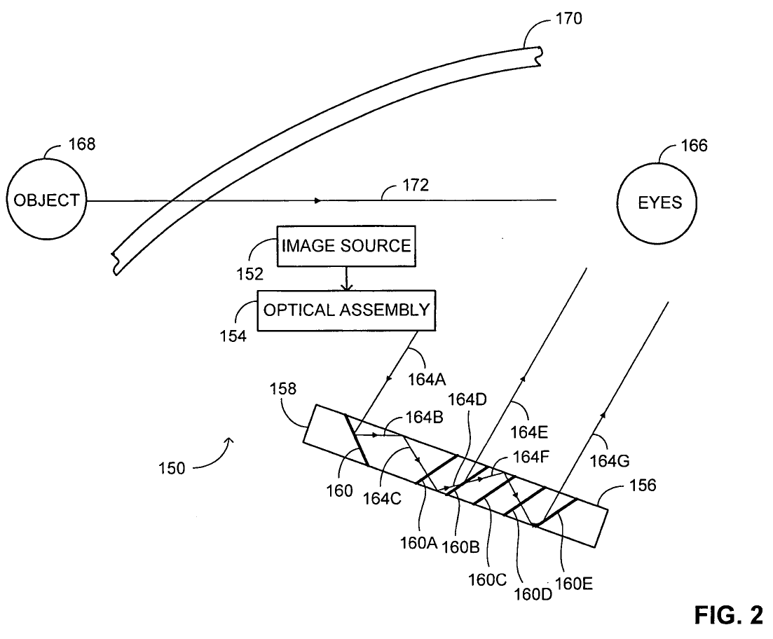

Reference is now made to FIG. 2, which is a schematic illustration of a system, generally referenced 150, for displaying a plurality of virtual images respective of an incident image having a focal point substantially located at infinity, constructed and operative in accordance with another embodiment of the disclosed technique. System 150 includes an image source 152, an optical assembly 154, and a planar optical module 156. Planar optical module 156 includes a planar light guide 158, a reflective surface 160 and a plurality of partially reflective surfaces 162A, 162B, 162C, 162D and 162E. Reflective surface 160 and partially reflective surfaces 162A, 162B, 162C, 162D and 162E are located within planar light guide 158.

Image source 152 is coupled with optical assembly 154. Planar optical module 156 is optically coupled with optical assembly 154. Planar optical module 156 is located in the vicinity of an instrument panel (not shown) of the vehicle. Hence, system 150 operates as an HDD. Optical assembly 154 receives an incident image (not shown) from image source 152, and directs a collimated light beam 164A at an incidence angle (not shown), toward reflective surface 160. Reflective surface 160 reflects collimated light beam 164A as a light beam 164B, and couples light beam 164B within planar light guide 158 by TIR, as a coupled light beam 164C.

Since the incidence angle of coupled light beam 164C relative to partially reflective surface 160A is substantially zero, coupled light beam 164C passes through partially reflective surface 160A without reflection and is further reflected by TIR, as another coupled light beam 164D. Partially reflective surface 160B reflects part of coupled light beam 164D as a decoupled light beam 164E toward eyes 166 of an operator (not shown). Partially reflective surface 160B transmits another part of coupled light beam 164D, as a light beam 164F. In the same manner, partially reflective surface 160E decouples a decoupled light beam 164G toward eyes 166.

Since light beam 164A is collimated, decoupled light beams 164E and 164G are also collimated, whereby planar optical module 156 displays the output decoupled images for eyes 166, substantially at an infinite distance from the operator. This feature allows the operator to look back and forth between planar optical module 156, and an object 168 located substantially at an infinite distance from the operator, through a windshield 170 and via a light beam 172, without having to repeatedly focus eyes 166 between the output decoupled images and a scene image (not shown) of object 168. It is noted that the planar optical module of FIG. 2 can be employed in system 100 of FIG. 1, replacing planar optical module 106. It is further noted that either system 100 or system 150 can be incorporated with a head-mounted display.

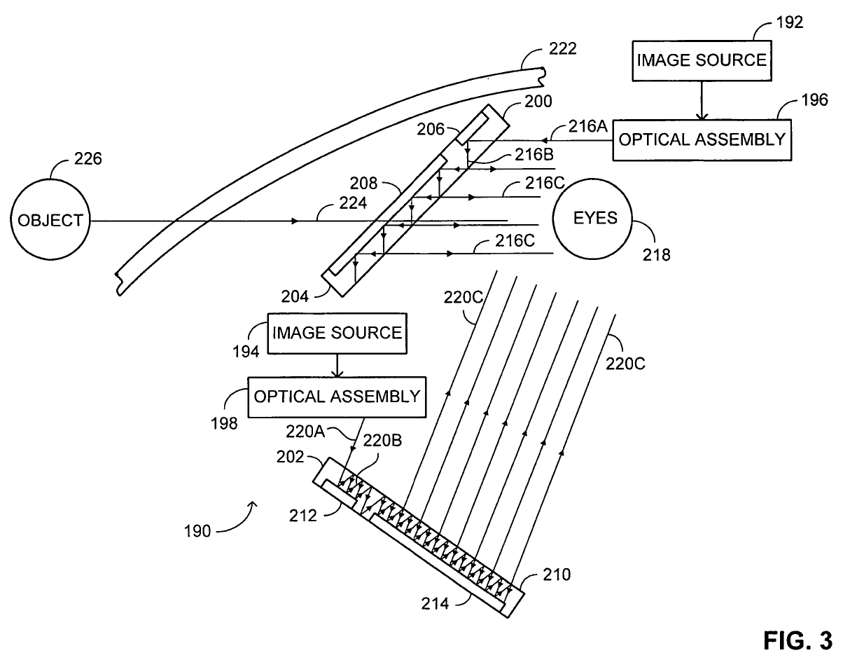

Reference is now made to FIG. 3, which is a schematic illustration of a system, generally referenced 190, for displaying two sets of virtual images respective of two incident images having focal points substantially located at infinity, constructed and operative in accordance with a further embodiment of the disclosed technique. System 190 includes a first image source 192, a second image source 194, a first optical assembly 196, a second optical assembly 198, a first planar optical module 200 and a second planar optical module 202. First planar optical module 200 includes a first planar light guide 204, a first input BTE 206 and a first output BTE 208. Second planar optical module 202 includes a second planar light guide 210, a second input BTE 212 and a second output BTE 214.

First image source 192, first optical assembly 196 and first planar optical module 200 are arranged in a manner similar to system 100 (FIG. 1), thereby operating as a HUD. Second image source 194, second optical assembly 198 and second planar optical module 202 are arranged in a manner similar to system 150 (FIG. 2), thereby operating as an HDD.

First optical assembly 196 receives a first incident image (not shown) from first image source 192, and first optical assembly 196 directs a first collimated light beam 216A at a first incidence angle (not shown), toward first input BTE 206. First input BTE 206 couples first collimated light beam 216A as a first set of coupled light beams 216B into first planar light guide 204. First output BTE 208 decouples the first set of coupled light beams 216B into first decoupled light beams 216C, out of first planar light guide 204 at a first output angle (not shown) substantially equal to the first incidence angle, toward eyes 218 of the operator (not shown), thereby forming a first set of output decoupled images (not shown).

Second optical assembly 198 receives a second incident image (not shown) from second image source 194, and second optical assembly 198 directs a second collimated light beam 220A at a second incidence angle (not shown), toward second input BTE 212. Second input BTE 212 couples second collimated light beam 220A as a second set of coupled light beams 220B into second planar light guide 210. Second output BTE 214 decouples the second set of coupled light beams 220B into second decoupled light beams 220C, out of second planar light guide 210 at a second output angle (not shown) substantially equal to the second incidence angle, toward eyes 218, thereby forming a second set of output decoupled images (not shown).

A windshield 222 of a vehicle (not shown) and first planar optical module 200 transmit a light beam 224 respective of a scene image (not shown) of an object 226 located substantially at an infinite distance from the operator, toward eyes 218. Since first decoupled light beams 216B and second decoupled light beams 220C are collimated, eyes 218 perceive focal points of the first set of output decoupled images and the second set of output decoupled images, respectively, to be located at an infinite distance from the operator. Hence, eyes 218 can repeatedly switch between the first set of output decoupled images against the scene image, and the second set of output decoupled images, with greater ease and less fatigue, compared to HUDs and HDDs as known in the art.

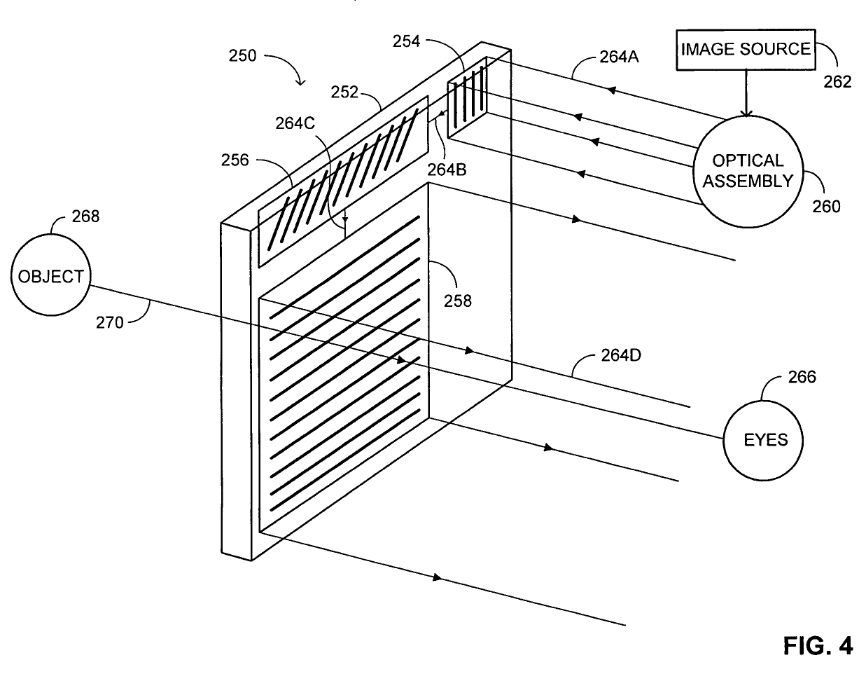

Reference is now made to FIG. 4, which is a schematic illustration of a planar optical module, generally referenced 250, similar to the planar optical module of the system of FIG. 1 and the planar optical module of the system of FIG. 2, constructed and operative in accordance with another embodiment of the disclosed technique. Planar optical module 250 includes a planar light guide 252, an input BTE 254, an intermediate BTE 256 and an output BTE 258. Input BTE 254, intermediate BTE 256 and output BTE 258 are incorporated with planar light guide 252. The arrangement of an input BTE, an intermediate BTE and an output BTE with a planar light guide is herein below referred to as “triplet”.

Input BTE 254 and intermediate BTE 256 are located along a first axis (not shown). Intermediate BTE 256 and output BTE 258 are located along a second axis (not shown) substantially perpendicular to the first axis. The microgroove direction of input BTE 254 is substantially normal to the first axis. The microgroove direction of intermediate BTE 256 is approximately 45 degrees counterclockwise relative to the microgroove direction of input BTE 254. The microgroove direction of output BTE 258 is substantially normal to that of input BTE 254.

The contour of input BTE 254 is a square having a side A. The contour of intermediate BTE 256 is a rectangle of a width A and a length B. The contour of output BTE 258 is a square having a side B. Intermediate BTE 256 and output BTE 258 are located such that width A of intermediate BTE 256 is substantially normal to the first axis.

An optical assembly 260 receives an incident image (not shown) from an image source 262, and optical assembly 260 directs a collimated light beam 264A at an incidence angle (not shown), toward input BTE 254. Input BTE 254 couples collimated light beam 264A as a set of coupled light beams 264B into planar light guide 252. Intermediate BTE 256 couples the set of coupled light beams 264B as another set of coupled light beams 264C into planar light guide 252. Output BTE 258 decouples the set of coupled light beams 264C into decoupled light beams 264D, out of planar light guide 252 at an output angle (not shown) substantially equal to the incidence angle, toward eyes 266 of an operator (not shown), thereby forming a plurality of output decoupled images (not shown).

Since decoupled light beams 264D are collimated, eyes 266 perceive the focal point of the output decoupled images to be located substantially at an infinite distance from the operator. If planar optical module 250 is incorporated in a HUD, eyes 266 can detect the output decoupled images against a scene image of an object 268 whose focal point is located substantially at an infinite distance from the operator, via a light beam 270 transmitted through planar optical module 250. It is noted that by incorporating intermediate BTE 256 with planar light guide 252, the surface area of input BTE 254 can be selected to be substantially smaller than that of input BTE 110 (FIG. 1), while planar optical module 250 provides the same eyebox as that of planar optical module 106.

According to another aspect of the disclosed technique, the image source includes an image data source and an image reproduction apparatus. The image reproduction apparatus produces the incident image according to a video input received from the image data source, by scanning a modulated laser beam, horizontally and vertically. The reproduced incident image is then projected toward an input BTE of a planar optical module, to be viewed by the eyes of an observer.

The term “speckles” herein below, refers to substantially dark and bright spots in an image which is produced by a laser beam scattered from a substantially rough surface. The substantially dark and bright spots form in the image, when the laser beams within each spot interfere destructively or constructively, respectively. Since speckles reduce the resolution of the image considerably, it is desirable to reduce their existence. One way to reduce speckles as known in the art, is by projecting the laser through a time varying diffuser.

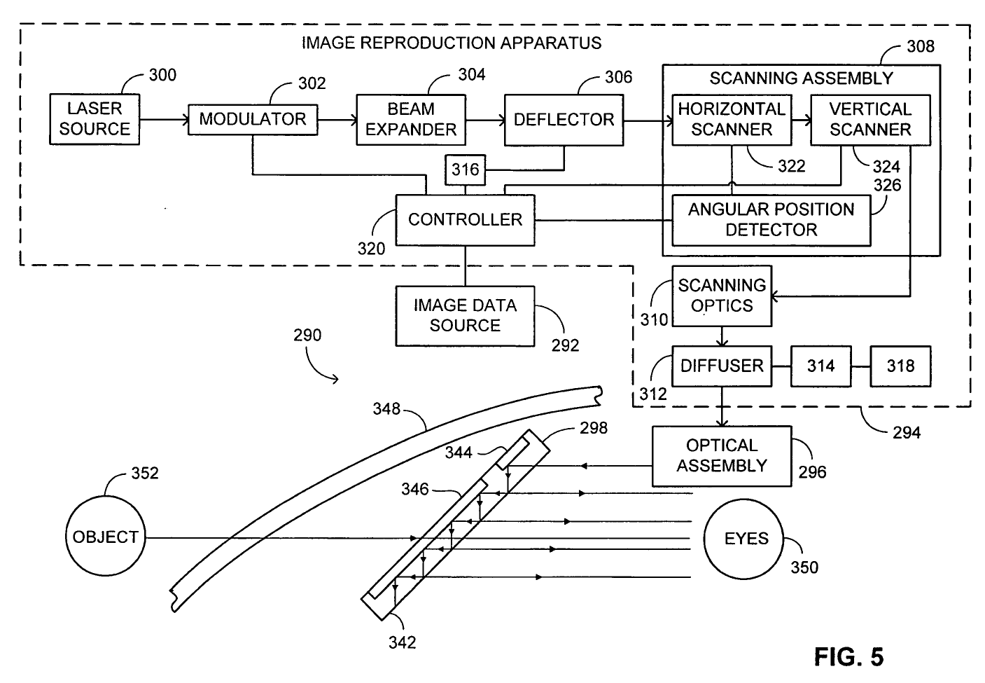

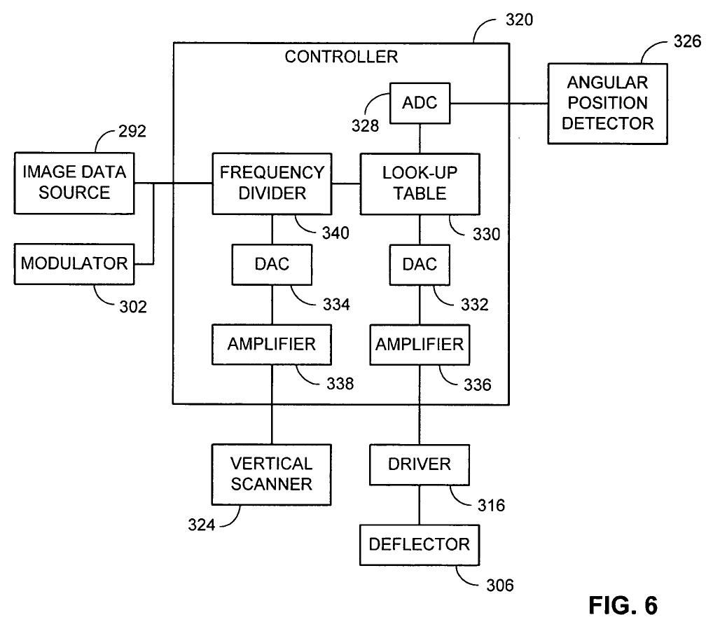

Reference is now made to FIGS. 5 and 6. FIG. 5 is a schematic illustration of a system, generally referenced 290, for displaying a plurality of virtual images respective of an incident image having a focal point substantially located at infinity, against a scene image of an object substantially located at infinity, constructed and operative in accordance with a further embodiment of the disclosed technique. FIG. 6 is a schematic illustration of a controller of the system of FIG. 5, generally referenced 320.

System 290 includes an image data source 292, an image reproduction apparatus 294, an optical assembly 296 and a planar optical module 298. Image reproduction apparatus 294 includes a laser source 300, a modulator 302, a beam expander 304, a deflector 306, a scanning assembly 308, scanning optics 310, a diffuser 312, drivers 314 and 316, and controllers 318 and 320. Scanning assembly 308 includes a horizontal scanner 322, a vertical scanner 324 and an angular position detector 326. Controller 320 (i.e., system controller—FIG. 6) includes an analog to digital converter 328 (ADC), a look-up table 330, digital to analog converters 332 and 334 (DAC), amplifiers 336 and 338 and a frequency divider 340. Planar optical module 298 includes a planar light guide 342, an input BTE 344 and an output BTE 346.

Laser source 300 is a device which produces laser. Laser source 300 can be either an independent device, or incorporated with an integrated circuit (IC —not shown, i.e., solid-state surface-emitting laser). Alternatively, laser source 300 can be in form of a wound optical fiber which is optically pumped at predetermined locations along the length of the optical fiber. Modulator 302 is a device which modulates an incoming light beam, for example, by blocking the incoming light beam or transmitting the incoming light beam, in a certain sequence (i.e., on-off keying—OOK). The OOK can be either return to zero (RZ) or non-return to zero (NRZ).

Beam expander 304 is a device which enlarges the diameter (i.e., cross section) of the laser beam. Beam expander 304 can be derived for example, from a reverse Galilean telescope. Deflector 306 is a device which changes the angle of direction of the incident laser beam. In case of an acousto-optic deflector, the change in the direction of the laser beam is proportional to an acoustic frequency inputted to deflector 306. In case of an electro-optical deflector, the change in the angle depends on an electric potential applied between two electrodes which encompass an electro-optical layer. It is noted that modulator 302 can operate both as a modulator and a deflector, in which case deflector 306 can be eliminated from the system.

Horizontal scanner 322 can be a resonance type scanner, a scanner implemented on a microelectromechanical system—MEMS device, and the like, as known in the art. Horizontal scanner 322 oscillates at a resonant frequency thereof, for example according to a sine waveform. Vertical scanner 324 can be a galvanometer based scanner, and the like, as known in the art, and can be implemented on a MEMS. Scanning optics 310 includes one or more optical elements (not shown), in order to direct an image in a predetermined direction. Diffuser 312 is an optical element which is operative to reduce speckles in an image (not shown) reproduced by system 290. Diffuser 312 can be either of the rotating type or the vibrating type. Diffuser 312 reduces the contrast among speckles, by temporally varying the phase of a plurality of cells within each speckle, thereby destroying the spatial coherence among the cells.

Controller 318 is a device which produces a waveform (e.g., a sine wave). Alternatively, controller 318 produces a waveform in synchrony with other elements of system 290 (e.g., in synchrony with the scanning frequency of vertical scanner 324). Optical assembly 296 and planar optical module 298 are similar to optical assembly 104 (FIG. 1) and planar optical module 106, respectively, as described herein above.

Modulator 302 is optically coupled with laser source 300 and with beam expander 304, and electrically coupled with image data source 292 and with frequency divider 340. Beam expander 304 is optically coupled with modulator 302 and with deflector 306. Deflector 306 is optically coupled with horizontal scanner 322, and electrically coupled with driver 316. Horizontal scanner 322 is optically coupled with vertical scanner 324, and is further coupled with angular position detector 326. Vertical scanner 324 is optically coupled with scanning optics 310. Scanning optics 310 is optically coupled with diffuser 312. Diffuser 312 is optically coupled with optical assembly 296, and electrically coupled with driver 314. Driver 314 is coupled with controller 318 (i.e., diffuser controller).

ADC 328 is coupled with angular position detector 326 and with look-up table 330. DAC 332 is coupled with look-up table 330 and with amplifier 336. Driver 316 is coupled with amplifier 336 and with deflector 306. Frequency divider 340 is coupled with look-up table 330, image data source 292, and with modulator 302. DAC 334 is coupled with frequency divider 340 and with amplifier 338. Amplifier 338 is coupled with DAC 334 and with vertical scanner 324. Optical assembly 296 is optically coupled with input BTE 344. Planar optical module 298 is located behind a windshield 348 of a vehicle (not shown), and in a line of sight of eyes 350 of an operator (not shown) to an object (i.e., a scene) 352.

Modulator 302 modulates the laser beam (not shown) according to a control input from controller 320, as described herein below. Beam expander 304 expands the modulated laser beam from a substantially small diameter to a substantially large diameter and transmits the expanded laser beam to deflector 306. Deflector 306 transmits the laser beam to horizontal scanner 322, while deflecting the laser beam according to the control input from controller 320, as described herein below. Horizontal scanner 322 scans the laser beam along a horizontal axis (not shown) at a resonant frequency thereof. Vertical scanner 324 scans the horizontally scanned laser beam along a vertical axis (not shown) substantially perpendicular to the horizontal axis, at a frequency which is a division of the resonant frequency of horizontal scanner 322, and which is determined by controller 320 as described herein below. In this manner, vertical scanner 324 reproduces a frame of the image which is stored in image data source 292.

Scanning optics 310 directs the reproduced image toward diffuser 312, diffuser 312 reduces the speckles in the reproduced image and directs the reproduced image toward optical assembly 296. Optical assembly 296 collimates the reproduced image, such that the focal point of the reproduced image is located substantially at infinity, and projects the collimated reproduced image toward input BTE 344.

Input BTE 344 couples light beams respective of the reproduced image toward output BTE 346 within planar light guide 342, and output BTE 346 decouples the coupled light beams toward eyes 350. In this manner, eyes 350 can observe an output decoupled image respective of the reproduced image, against a scene image (not shown) of object 352, and perceive the focal point of the output decoupled image to be located substantially at the same focal point as that of object 352 (i.e., at infinity). Thus, system 290 operates as a HUD.

The combined motion of horizontal scanner 322 and vertical scanner 324 forms a sinusoidal raster in a vertical direction, where a raster line spacing (not shown) in the sinusoidal raster, is substantially uniform at a center thereof, and becomes progressively non-uniform toward the edges. The non-uniformities at the edges tend to distort the reproduced image. Therefore, it is desirable to reduce the non-uniformities in order to increase the vertical resolution of the reproduced image. The sinusoidal raster can be an interlacing raster (i.e., alternately projecting the odd lines and the even lines), progressive raster (i.e., projecting the odd lines and the even lines at the same time), and the like.

According to the disclosed technique, angular position detector 326 monitors the angular position of horizontal scanner 322 and produces an analog position output (i.e., horizontal position output) for ADC 328. In the following description it is assumed that horizontal scanner 322 is a resonant scanner, thereby scanning the laser beam according to a substantially sinusoidal waveform. Hence, the analog position output of angular position detector 326 is substantially sinusoidal. ADC 328 converts the analog position output to a digital output. Look-up table 330 includes an angular deflection value for each horizontal position output.

ADC 328 converts the analog horizontal position output to a digital horizontal output A. Each digital horizontal output A represents the amplitude of the sine wave as a function of time. Look-up table 330 outputs an angular deflection value at time t, according to a substantially arcsin shaped function, or one or more harmonics thereof, where the argument of this arcsin function,
β=sin(ωt)−A (1)
where ω is the resonant frequency of horizontal scanner 322, and A is the angular position of horizontal scanner 322 detected by angular position detector 326 at time t (i.e., the horizontal position output). Look-up table 330 outputs the angular deflection value to DAC 332 to convert the angular deflection value to analog format and for amplifier 336 to amplify the angular deflection value. Deflector 306 receives this angular deflection value from controller 320 through driver 316, and deflects the laser beam by this angular deflection value along the substantially vertical scanning axis of vertical scanner 324. In this manner the difference between the edge line spacing at an edge of the sinusoidal raster, and the center line spacing at a center of the sinusoidal raster is reduced, thereby improving the reproduced image.

Controller 320 controls the operation of modulator 302 according to the feedback from angular position detector 326 and the image data which image data source 292 outputs to controller 320. Controller 320 directs deflector 306 to deflect the laser beam along the vertical axis, via driver 316, according to the feedback from angular position detector 326. Controller 320 can direct deflector 306 to operate for example, at twice the resonant frequency of horizontal scanner 322. Controller 320 controls the frequency of vertical scanner 324 according to this feedback signal.

Frequency divider 340 produces a signal at a frequency which is a predetermined fraction of the frequency of horizontal scanner 322 (i.e., produces a vertical position output according to an integration of the horizontal position output), according to the output of angular position detector 326. DAC 334 converts the vertical position output to analog format and amplifier 338 amplifies this analog vertical position output. Vertical scanner 324 scans the horizontally scanned laser beam, according to the signal produced by frequency divider 340 and amplified by amplifier 338. For example, if angular position detector 326 detects that horizontal scanner 322 is horizontally scanning at 1000 Hz, then controller 320 directs vertical scanner 324 to scan vertically at 25 Hz.

Controller 320 can further include a phase shifter (not shown) coupled for example, with frequency divider 340 and with DAC 334, to alternately shift the waveform determined by frequency divider 340, by quarter of a cycle, thereby forming an interlacing raster. Controller 320 can control vertical scanner 324 according to a predetermined saw-tooth waveform which is alternately shifted by one quarter of a cycle of the oscillation waveform of horizontal scanner 322, thereby forming an interlacing raster. In this case, horizontal scanner 322 is driven according to another predetermined saw-tooth waveform.

This is true also in case of a horizontal scanner which is implemented on MEMS and driven according to a predetermined saw-tooth waveform, by a dedicated controller (not shown). Controller 320, then drives vertical scanner 324 according to another saw-tooth waveform alternately shifted from the waveform of horizontal scanner 322 by quarter of a cycle. In this case, the raster line spacing of the reproduced image is substantially uniform, and hence, deflector 306 can be eliminated from the system. It is further noted that in case of a MEMS implementation, angular position detector 326 can be integrated with horizontal scanner 322.

Image data source 292 includes data respective of modulation property of each pixel of every frame of the incident image (e.g., whether a certain pixel in a certain frame should be dark or bright). Frequency divider 340 is aware of the pixel in the frame which is currently being scanned by cumulative operation of horizontal scanner 322 and vertical scanner 324 (i.e., the horizontal and vertical index of the pixel in that frame). Frequency divider 340 provides information respective of the current pixel (i.e., the horizontal and vertical index) to modulator 302, and modulator 302 modulates the laser beam according to data in image data source 292, respective of that pixel.

It will be appreciated by persons skilled in the art that the disclosed technique is not limited to what has been particularly shown and described hereinabove. Rather the scope of the disclosed technique is defined only by the claims, which follow.

1. System for displaying an incident image for an operator of a vehicle, the system comprising:
an optical assembly receiving said incident image from an image source, said optical assembly producing a collimated light beam according to said incident image; and
a planar optical module optically coupled with said optical assembly, said planar optical module being located in a line of sight of said operator, said planar optical module displaying a set of output decoupled images, each of said output decoupled images being similar to said incident image, and each of said output decoupled images having a focal point substantially located at an infinite distance from said operator,
wherein said planar optical module decouples decoupled light beams respective of said output decoupled images, toward the same side of said planar optical module, at which said optical assembly directs said collimated light beam toward said planar optical module.

2. The system according to claim 1, wherein said planar optical module comprises:
a planar light guide;
a reflective surface located within said planar light guide; and
a plurality of partially reflective surfaces located within said planar light guide,
wherein said reflective surface couples said collimated light beam into said planar light guide, as a set of coupled light beams, by reflecting said collimated light beam, and
wherein at least one of said partially reflective surfaces transmits at least a portion of said set of coupled light beams, and decouples at least another portion of said set of coupled light beams by reflecting said other portion, thereby forming said set of output decoupled images.

3. The system according to claim 1, wherein said planar optical module comprises:
a planar light guide;
an input beam transforming element incorporated with said planar light guide; and
an output beam transforming element incorporated with said planar light guide,
wherein said input beam transforming element receives said collimated light beam from said optical assembly, said input beam transforming element couples said collimated light beam into said planar light guide, as a set of coupled light beams, and
wherein said output beam transforming element receives from said planar light guide and decouples as decoupled light beams, a set of coupled light beams, thereby forming said set of output decoupled images.

4. The system according to claim 3, wherein said planar optical module further comprises an intermediate beam transforming element incorporated with said planar light guide,
wherein said intermediate beam transforming element is associated with said input beam transforming element and with said output beam transforming element,
wherein said intermediate beam transforming element receives a set of coupled light beams associated with said intermediate beam transforming element and with said input beam transforming element, and
wherein said intermediate beam transforming element spatially transforms said set of coupled light beams into said planar light guide, as another set of coupled light beams.

5. The system according to claim 3, wherein each of said input beam transforming element and said output beam transforming element, is selected from the list consisting of:
refraction light beam transformer; and
diffraction light beam transformer.

6. The system according to claim 5, wherein said refraction light beam transformer is selected from the list consisting of:
prism;
Fresnel lens;
micro-prism array;
gradient index lens; and
gradient index micro-lens array.

7. The system according to claim 5, wherein said diffraction light beam transformer is a diffraction optical element.

8. The system according to claim 1, further comprising said image source.

9. The system according to claim 1, wherein said line of sight points toward a scene located at said focal point relative to said operator,
wherein said planar optical module is substantially transparent, and
wherein said planar optical module transmits a scene-image light beam respective of said scene, toward the eyes of said operator.

10. The system according to claim 1, wherein said image source is selected from the list consisting of:
liquid crystal display;
light emitting diode;
organic light emitting diode;
cathode ray tube;
liquid crystal on silicon;
laser;
scanned laser;
scanned light emitting diode;
hot cathode fluorescent lamp;
cold cathode fluorescent lamp;
incandescent light element;
flat panel display;
still image projector; and
starlight scope;

11. The system according to claim 1, wherein an output angle of said decoupled light beams, is substantially equal to an incidence angle of said collimated light beam.

12. The system according to claim 1, wherein said image source comprises:
an image data source including image data respective of every frame of said incident image, each of said frames including a plurality of pixels; and
an image reproduction apparatus coupled with said image data source, said image reproduction apparatus reproducing said incident image according to said image data, said image reproduction apparatus comprising:
a horizontal scanner scanning a modulated laser beam along a substantially horizontal axis, thereby producing a horizontally scanned laser beam;
a vertical scanner scanning said horizontally scanned laser beam along a substantially vertical axis substantially perpendicular to said substantially horizontal axis, thereby sequentially producing said frames;
an angular position detector coupled with said horizontal scanner, said angular position detector detecting the position of said horizontal scanner, thereby producing a horizontal position output;
a system controller coupled with said angular position detector and with said image data source;
a laser source for producing a laser beam; and
a modulator optically coupled with said laser source and with said horizontal scanner, and electrically coupled with said system controller, said system controller controlling the operation of said modulator according to said horizontal position output and according to said image data to modulate said laser beam, said system controller further controlling the operation of said vertical scanner according to said horizontal position output.

13. The system according to claim 12, further comprising a beam expander optically coupled between said modulator and said horizontal scanner, said beam expander producing an enlarged laser beam by enlarging a cross section of said modulated laser beam.

14. The system according to claim 13, further comprising a dynamic deflector, optically coupled between said beam expander and said horizontal scanner, said system controller being further coupled with said angular position detector and with said dynamic deflector, said system controller determining an angular deflection value according to said horizontal position output, said system controller controlling the operation of said dynamic deflector to deflect said enlarged laser beam along said substantially vertical axis, by said angular deflection value, to reduce the difference between an edge line spacing at an edge of said incident image, and a center line spacing at a center of said incident image.

15. The system according to claim 14, wherein said system controller comprises a look-up table coupled with said angular position detector and with said dynamic deflector, said system controller determining said angular deflection value according to said look-up table.

16. The system according to claim 12, further comprising a dynamic deflector optically coupled between said modulator and said horizontal scanner, said system controller being further coupled with said angular position detector and with said dynamic deflector, said system controller determining an angular deflection value according to said horizontal position output, said system controller controlling the operation of said dynamic deflector to deflect said modulated laser beam along said substantially vertical axis, by said angular deflection value, to reduce the difference between an edge line spacing at an edge of said incident image, and a center line spacing at a center of said incident image.

17. The system according to claim 16, wherein said system controller comprises:
an analog to digital converter (ADC) coupled with said angular position detector, said ADC producing a digital horizontal position output by converting said horizontal position output from analog format to digital format;
a look-up table coupled with said ADC, said look-up table including an angular deflection value for said digital horizontal position output;
a first digital to analog converter (DAC) coupled with said look-up table, said first DAC producing an analog angular deflection value by converting said angular deflection value from digital format to analog format;
a first amplifier coupled with said first DAC and with said dynamic deflector, said first amplifier producing an amplified analog angular deflection value by amplifying said analog angular deflection value;
a frequency divider coupled with said look-up table, said image data source, and with said modulator, said frequency divider determining a vertical position output according to an integration of said digital horizontal position output;
a second DAC coupled with said frequency divider, said second DAC producing an analog vertical position output by converting said vertical position output from digital format to analog format; and
a second amplifier coupled with said second DAC and with said vertical scanner, said second amplifier producing an amplified analog vertical position output, by amplifying said analog vertical position output,
wherein said dynamic deflector operates according to said amplified analog angular deflection value,
wherein said vertical scanner operates according to said amplified analog vertical position output,
wherein said frequency divider provides said modulator positional information respective of a pixel among said pixels which is currently being scanned by mutual operation of said horizontal scanner and said vertical scanner, according to said horizontal position output and said vertical position output, and
wherein said modulator modulates said laser beam according to said positional information and said image data.

18. The system according to claim 12, wherein said system controller comprises a frequency divider coupled with said angular position detector, said frequency divider determining a vertical position output according to an integration of said horizontal position output, and
wherein said system controller controls the operation of said vertical scanner according to said vertical position output.

19. The system according to claim 12, wherein said system controller comprises a frequency divider coupled with said angular position detector, said image data source, and with said modulator, said frequency divider determining a vertical position output according to an integration of said horizontal position output, said frequency divider providing said modulator positional information respective of a pixel among said pixels which is currently being scanned by mutual operation of said horizontal scanner and said vertical scanner, according to said horizontal position output and said vertical position output, and
wherein said modulator modulates said laser beam according to said positional information and said image data.

20. The system according to claim 12, further comprising scanning optics optically coupled between said vertical scanner and said optical assembly, said scanning optics directing said incident image toward said optical assembly.

21. The system according to claim 20, further comprising:
a diffuser optically coupled between said scanning optics and said optical assembly; and
a diffuser controller electrically coupled with said diffuser,
wherein said diffuser controller controls the operation of said diffuser, to reduce speckles in said incident image.

22. The system according to claim 12, further comprising:
a diffuser optically coupled between said vertical scanner and said optical assembly; and
a diffuser controller electrically coupled with said diffuser,
wherein said diffuser controller controls the operation of said diffuser, to reduce speckles in said incident image.

23. The system according to claim 12, wherein said horizontal scanner is selected from the list consisting of:
resonance type scanner; and
microelectromechanical system based scanner.
